(19) United States
(12) Patent Application Publication
(10) Pub. No.: US 2025/0182929 A1
(43) Pub. Date: Jun. 5, 2025

(54) INDICATING CABLE TEMPERATURE WITH CHROMOGENIC POLYMER COATINGS

(71) Applicant: INTERNATIONAL BUSINESS MACHINES CORPORATION, ARMONK, NY (US)

(72) Inventors: ANDREW C. M. HICKS, HIGHLAND, NY (US); JOHN S. WERNER, FISHKILL, NY (US); RAFAELA FROTA, POUGHKEEPSIE, NY (US); FAEZEH GHOLAMI, RIDGEWOOD, NJ (US)

(21) Appl. No.: 18/526,296

(22) Filed: Dec. 1, 2023

(51) Int. Cl. H01B 7/32

(52) U.S. Cl. CPC H01B 7/324

(57) ABSTRACT

Methods, apparatus, and systems for indicating cable temperature with chromogenic polymer coatings include determining, based on a temperature threshold, a material for a chromogenic polymer coating, wherein the chromogenic polymer coating is configured to change color based on a temperature of the chromogenic polymer coating exceeding the temperature threshold, and applying the chromogenic polymer coating to a surface of a cable.

### BACKGROUND

### Field of the Disclosure

The field of the disclosure is cable identifiers, or, more specifically, methods and systems for indicating cable temperature with chromogenic polymer coatings.

### Description of Related Art

Cables may, during normal use, become hot to the touch due to the surrounding environment or current flowing through the cable, which may change over time. Users may not be aware of how hot a cable or cable connector is and may get burned if they touch a hot cable. Similarly, users may be unaware of whether a cable has voltage applied, which could pose a risk to the user if they touch connector pins or attempt to hot plug the cable to a product. Further, the performance of cables may be impacted by bends, cuts, or other manipulations of the cable. It would be helpful for users to know whether or not a cable is hot or if voltage is running through the cable.

### SUMMARY

Methods and systems for indicating cable temperature with chromogenic polymer coatings according to various embodiments are disclosed in this specification. In accordance with one aspect of the present disclosure, a method of indicating temperature of cables may include determining, based on a temperature threshold, a material for a chromogenic polymer coating, wherein the chromogenic polymer coating is configured to change color based on a temperature of the chromogenic polymer coating exceeding the temperature threshold, and applying the chromogenic polymer coating to a surface of a cable.

In accordance with another aspect of the present disclosure, indicating cable temperature with chromogenic polymer coatings may include an apparatus including a cable, and a chromogenic polymer coating applied to a surface of the cable, wherein the chromogenic polymer coating is configured to change color based on a temperature of the chromogenic polymer coating exceeding a temperature threshold.

The foregoing and other objects, features and advantages of the disclosure will be apparent from the following more particular descriptions of exemplary embodiments of the disclosure as illustrated in the accompanying drawings wherein like reference numbers generally represent like parts of exemplary embodiments of the disclosure.

### BRIEF DESCRIPTION OF THE DRAWINGS

FIG. 1 shows an example line drawing of a cable configured for indicating cable temperature with chromogenic polymer coatings in accordance with embodiments of the present disclosure.

FIG. 2 shows an example line drawing of a cable configured for indicating cable temperature with chromogenic polymer coatings in accordance with embodiments of the present disclosure.

FIG. 3 shows an example line drawing of a cable configured for indicating cable temperature with chromogenic polymer coatings in accordance with embodiments of the present disclosure.

FIG. 4 is a flowchart of an example method for indicating cable temperature with chromogenic polymer coatings according to some embodiments of the present disclosure.

FIG. 5 is a flowchart of an example method for indicating cable temperature with chromogenic polymer coatings according to some embodiments of the present disclosure.

### DETAILED DESCRIPTION

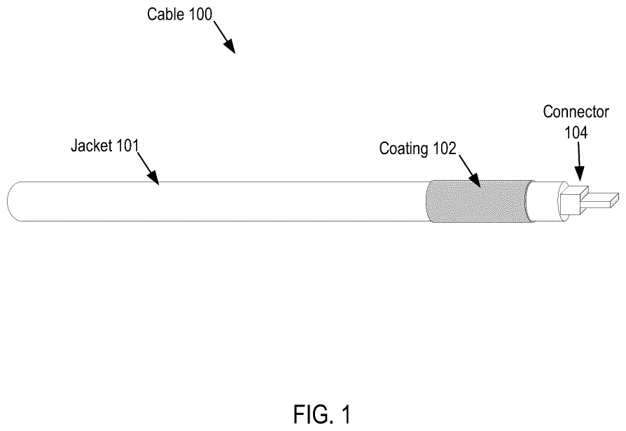

Exemplary methods, apparatus, and systems for indicating cable temperature with chromogenic polymer coatings in accordance with the present disclosure are described with reference to the accompanying drawings, beginning with FIG. 1. FIG. 1 sets forth an example line drawing of a cable configured for indicating cable temperature with chromogenic polymer coatings in accordance with embodiments of the present disclosure. The example of FIG. 1 includes a cable 100, which includes a jacket 101, a coating 102 and a connector 104.

The example cable 100 in FIG. 1 may be any type of cable, such as a power cable, a signal cable, a fiber optic cable, and the like. Cable 100 may include a connector at one or more of the cable's endpoints, such as connector 104 shown in FIG. 1. The exterior surface of the cable 100 includes a jacket 101 that is configured to surround the interior portion of the cable. For example, the cable 100 of FIG. 1 may include an internal conductor, such as a cable, or multiple cables or wires, which may be surrounded by jacket 101.

The example coating 102 of FIG. 1 is a chromogenic polymer coating and is configured to change color when the coating 102 exceeds a threshold temperature. Other types of coatings configured to change color based on temperature may also be used. In one embodiment the coating 102 is applied to an external surface of the cable 100. The coating 102 may be applied to any part of the cable, such as the middle of the cable, near one end of the cable (as shown in FIG. 1), or even on a surface of the connector 104.

The coating 102 of FIG. 1 may be composed of chromogenic polymers, which may be configured to change color or transparency in response to temperature, electricity, temperature, mechanical force, PH variations, and the like. For example, an external stimulus such as light, voltage, heat, and the like, will trigger a partial or entire transformation of the polymer chemical structures of the coating, leading to changes in chemical and physical properties of the polymers. Such chromogenic polymers may be categorized as thermochromic, electrochromic, photochromic, hydrochromic, ionochromic, mechanochromic, and the like. In the example of FIG. 1, coating 102 is configured as a thermochromic chromogenic polymer coating configured to change color or transparency based on the temperature of the coating. In other embodiments, any other type of chromogenic polymers described above or otherwise may be utilized within the coating 102. For example, coating 102 may change colors based on the voltage applied to the cable 100. The composition of the coating 102 may be selected based on the desired properties to identify (such as temperature, voltage, etc.), as well as the specific value (such as a specific temperature) to be identified. For example, a specific coating 102 may be selected in order to identify when a cable reaches a temperature of 120 degrees Fahrenheit, which could be helpful in preventing accidental burns.

The example coating 102 of FIG. 1 is thermally coupled to cable 100. In one embodiment, there may be a thermal interface material (TIM) between the cable and the coating. In the embodiment of FIG. 1, the coating is thermally coupled to an external surface of cable 100, so that a user may be identified when the surface of the cable is hot to the touch. In another embodiment, the coating may be thermally coupled to the core of the cable (so as to identify when the cable has a voltage applied to it) or may be thermally coupled to the connector 104 of the cable, so as to identify when the connector 104 is hot to the touch (which could be at a temperature different from that of the surface of the cable). The coating 102 may be applied to the cable at a position different from where the cable is thermally coupled. For example, coating 102 may be applied in the middle of the cable while being thermally coupled to the connector (via a TIM or some other method) so as to identify the temperature of a connector without actually being applied to the connector.

Coating 102 of FIG. 1 may be configured to change to a specific color (or colors). That is, a user may select the material or physical makeup of the coating in order to select a base color, or to select which color (or transparency) the coating changes to, based on temperature (or any other property the chromogenic polymers are dependent on). For example, it would be useful for the coating to change to a color that differs from a color of the cable 100 so that a user may readily identify when the coating changes color. In another embodiment, different coatings may be color coordinated based on the temperature (or voltage) at which they change color, so as to easily identify which specific temperature a cable is based on the color a coating changes to. For example, different cables may have different temperature thresholds at which they should be identified (such as different types of cables, cables with varying thicknesses of jacketing, etc.). In another embodiment, different parts of a cable may have coatings with different temperature thresholds. For example, a cable connector may be thermally coupled to a coating that changes color at a threshold temperature lower than that of a coating thermally coupled to the exterior jacket of the cable, since the connector is composed of a material with a higher thermal conductivity than the material of the jacket. In such an example, the two coatings may also change to different colors to signify the different temperature thresholds at which they are dependent on. While the above embodiments have been described as having the temperature threshold for a coating by a limit that must be exceeded in order for the coating to change color or transparency, in other embodiments, the coating may be configured to change color when the temperature of the coating falls below a threshold temperature. In such an example, the coating may indicate when a cable becomes too cold. Although FIG. 1 shows a chromogenic polymer coating (such as coating 102) applied to a cable, in other embodiments, such a coating may be applied to other objects or components (such as a computer rack, computer components, plugs, and the like) in order to similarly indicate one or more properties (such as temperature, voltage, etc.) of such components.

In another embodiment, the coating 102 is configured to change, based on system performance and when exceeding the threshold temperature, from a color that absorbs light to a color that reflects light. In such an embodiment, as the cable increases in temperature, it may change colors to allow the cable to cool below the threshold temperature. In a similar embodiment, the cable is configured to absorb light when the temperature is below a threshold, causing the cable to heat up above the threshold. In such embodiments, the coating may be applied to all or a significant portion of the cable.

In another embodiment, the coating 102 is configured to change color based on an increase in pressure on the coating. For example, the cable is configured to change color when the cable is being crushed or a bend radius is exceeding. In such an embodiment, the color change provides the cable with a mechanism to indicate when the cable is being mishandled or is experiencing performance-affecting characteristics (such as rodent activity chewing on the cable, tight coiling radius, or pinching).

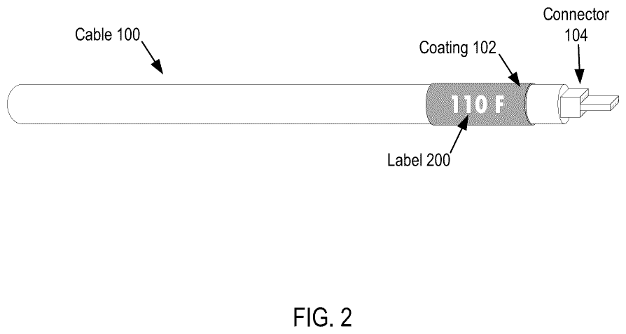

For further explanation, FIG. 2 sets forth another example line drawing of a cable configured for indicating cable temperature with chromogenic polymer coatings in accordance with embodiments of the present disclosure. The example of FIG. 2 differs from FIG. 1 in that FIG. 2 shows a label 200 as part of the coating 102. In some embodiments, the chromogenic polymer coating may be applied in such a way as to include a label that indicates the temperature of the cable. In one embodiment, the chromogenic polymer coating may be applied in the pattern of a label. In such an embodiment, if the chromogenic polymer coating changes from the color of the cable to a color different from the cable, then the label will become visible once the temperature of the chromogenic polymer coating exceeds the threshold temperature. In such an example, the label is visible only when the temperature of the coating exceeds the threshold temperature.

In another embodiment, such as the embodiment of FIG. 2, the chromogenic polymer coating may be applied in a pattern that excludes the label. For example, in FIG. 2, the label 200 stating “110 F” may comprise the surface of the cable, with the chromogenic polymer coating applied in a pattern around the label. In such an example, where the negative space of the coating allows the surface of the cable to show through the coating in the pattern of a label, and where the color of the chromogenic polymer coating changes from the color of the cable to a color different from the cable, the label will become visible only when the temperature of the coating exceeds the coating's threshold temperature, thereby changing the color of the coating around the label and causing the label to become visible.

In another embodiment, the label may be in the form of a sticker, a painted label, or some other coating applied on top of the chromogenic polymer coating, so as to prevent the area of the label from changing color when the underlying chromogenic polymer coating exceeds its temperature threshold. In such an embodiment, the label may be made to be the same color as the chromogenic polymer coating when the chromogenic polymer coating is under the temperature threshold, so that the label is visible only when the chromogenic polymer coating changes color once exceeding the temperature threshold. In such an embodiment, the color of the label or the color of the chromogenic polymer coating does not have to correlate with the color of the cable, so long as the color of the label corresponds with the base color of the chromogenic polymer coating.

In another embodiment, the label may be applied to the cable, via a sticker, paint, etc., and the chromogenic polymer coating may be applied on top of it in order to cover the label. In such an embodiment, the chromogenic polymer coating may be configured to change transparency (rather than color) in order to reveal the label and make it visible once the temperature threshold for the coating has been met. In such an embodiment, the color of the label must be different from the color of the underlying cable or connector in order to make the label visible. In some embodiments, different colors of labels may correspond with different temperature (or voltage) thresholds. As explained above, there are multiple different methods of applying coatings and labels to a cable. In some embodiments, the type of application of the coating may be dependent on the cable it is applied to, the property being measured (temperature, voltage, etc.), the part of the cable the coating is coupled to, and the like.

The label 200 may be any pattern configured to indicate temperature. In the embodiment of FIG. 2, the label is in the form of a specified temperature measurement (namely, “110 F”), which indicates the specific threshold temperature of the coating. In such an embodiment, the chromogenic polymer coating changes color to indicate, via the label, that the underlying cable is at least as hot as the temperature threshold indicated by the label. In another embodiment, the label 200 may be in the pattern of a symbol or icon, such as a flame, a hand, or some other pattern configured to indicate that the cable is too hot to handle. In some embodiments, different symbols or icons may indicate different threshold temperatures (or voltages). In another embodiment, the label may include additional information, such as which part of the cable the coating is thermally coupled to, by way of text, icons, symbols, or the like. For example, a coating applied to the exterior jacket of the coating may indicate the threshold temperature of the coating along with an indication that the threshold temperature is for the connector 104 of the coating. In another example, a coating may indicate that the label indicates a voltage and is electrically coupled to the core of the cable.

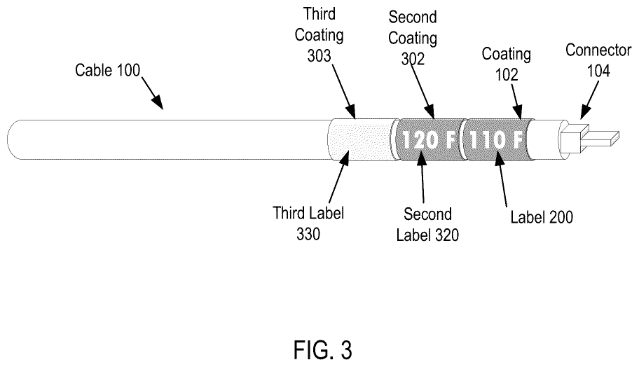

For further explanation, FIG. 3 sets forth another example line drawing of a cable configured for indicating cable temperature with chromogenic polymer coatings in accordance with embodiments of the present disclosure. The example of FIG. 3 differs from FIG. 2 in that FIG. 3 shows multiple coatings (such as coating 102, second coating 302, and third coating 303) with corresponding labels (label 200, second label 320, and third label 330) applied to the cable. In the embodiment of FIG. 3, multiple coatings are applied to the cable 100 in order to identify different temperature thresholds for the cable. For example, the three coatings are applied to the cable and are each thermally coupled to the exterior jacket of the cable in order to indicate the temperature of the cable's exterior. In the example of FIG. 3, each coating has a different temperature threshold, and thereby has a different physical makeup (selected by a user to select each specific temperature threshold of each coating). Accordingly, each coating in FIG. 3 has a different label to indicate the differing temperature thresholds.

In the example of FIG. 3, the labels of the three coatings are different. In another embodiment, the color of the labels (or the color the chromogenic polymer coating changes to) may also be different and may correspond with a color coding scheme for different threshold temperatures. In one embodiment, the base color (or starting color) of all three chromogenic polymer coatings is the same in order to minimize confusion of what the coatings are supposed to indicate as well as which coatings have already changed color. In the example of FIG. 3, only two of the three coatings (namely coating 102 and coating 302) have reached their respective temperature thresholds and thereby changed in color or transparency to make their corresponding label visible. That is, the third coating 303 has not yet changed in color and so has not yet revealed label 330. In such an example, a user viewing the cable 100 of FIG. 3 would be made known by the coatings that the temperature of the cable 100 is greater than or equal to 120° F. In an embodiment where the third label 330 is known to be 130° F., a user viewing the cable of FIG. 3 would know that the temperature of the cable 100 is between 120° F. and 130° F.

In another embodiment, the label may be made visible to a user independent of whether the chromogenic polymer coating has reached its temperature threshold and changed in color or transparency. In such an embodiment, the label may remain visible while the chromogenic polymer coating indicates to a user whether or not the value indicated by the label has been reached for the coating. For example, a cable having multiple coatings (similar to those shown in FIG. 3) with different corresponding labels may have the labels remain visible independent of whether the chromogenic polymer coating has changed color or transparency. In such an example, a user may readily identify which temperatures (or voltages) have been met by the cable while also knowing more about the upper limit of what the temperature (or voltage) of the cable could be. For example, if the third label of FIG. 3 was already visible and indicated a temperature of 125° F., then a user viewing the cable of FIG. 3 would know that the temperature of the cable 100 is between 120° F. and 125° F. Such an embodiment allows for additional information to be obtained by a user viewing the cable.

In the example of FIG. 3, the multiple coatings are positioned next to one another on the cable. In another embodiment, the multiple coatings may be spread out further along the cable or even located at different parts of the cable. In the example of FIG. 3, the multiple coatings are all thermally coupled to the same part of the cable. In another embodiment, one or more of the multiple coatings may be coupled to different parts of the cable.

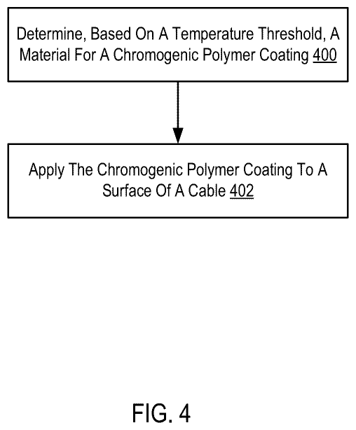

For further explanation, FIG. 4 sets forth a flow chart illustrating an exemplary method of indicating cable temperature with chromogenic polymer coatings according to embodiments of the present disclosure. The method of FIG. 4 includes determining 400, based on a temperature threshold, a material for a chromogenic polymer coating. Determining 400 a material for a chromogenic polymer coating may be carried out by selecting a material makeup for a coating that will change properties based on the specific temperature threshold. For example, one or more chromogenic polymers may be selected, or a specific combination of chromogenic polymers may be selected, that are known to change in color or transparency when reaching a temperature that matches the known temperature threshold. In such an example, a chromogenic polymer coating may be selected that is specific to a known temperature threshold.

The method of FIG. 4 also includes applying 402 the chromogenic polymer coating to a surface of a cable. Applying 402 the chromogenic polymer coating to a surface of a cable may be carried out by first applying an adhesive to the surface of the cable before then applying the coating to the adhesive. In another embodiment, the chromogenic polymer coating may have natural adhesive properties (or an adhesive may be added to the coating) and may be applied directly to the surface of the cable. In another embodiment, chromogenic polymer coating may be embedded within the cable at the time the cable is manufactured. In another embodiment, the coating may be in the form of a wrap that may be applied by a user to any part of the cable, such as by wrapping the coating around the cable. The surface of the cable that the coating is applied to may be any surface of the cable and on any part or component of the cable, such as the cable jacketing, a connector of the cable, and the like.

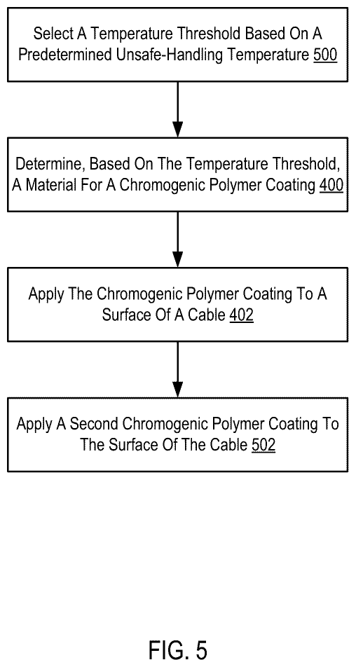

For further explanation, FIG. 5 sets forth a flow chart illustrating another exemplary method of indicating cable temperature with chromogenic polymer coatings according to embodiments of the present disclosure. The method of FIG. 5 includes selecting 500 a temperature threshold based on a predetermined unsafe-handling temperature. Selecting 500 a temperature threshold based on a predetermined unsafe-handling temperature may be carried out by selecting an unsafe-handling temperature based on which part of the cable the coating will be applied to. For example, a metal connector of a cable may have a known unsafe-handling temperature that is different from an unsafe-handling temperature of a jacketing of the cable, since the connector is composed of a material with a higher thermal conductivity than the material of the jacket. In selecting the temperature threshold of the coating to be applied to the cable, the coating can be made to indicate a temperature that would be useful for a user of the cable to know (such as whether or not the cable is too hot to handle).

The method of FIG. 5 also includes applying 502 a second chromogenic polymer coating to the surface of the cable. Applying 502 a second chromogenic polymer coating to the surface of the cable may be carried out by applying the coating directly to the surface of the cable. In other embodiments, more than two coatings may be applied to the same cable (or the same surface of the cable) in order to indicate multiple different properties of the cable or to indicate additional information about one property of the cable. For example, the second coating applied 502 to the cable may be based on a different temperature threshold than that of the first coating applied to the cable.

In view of the explanations set forth above, readers will recognize that the benefits of indicating cable temperature with chromogenic polymer coatings according to embodiments of the present disclosure include:
Decreasing potential risks of handling cables by indicating to a user of the cable information regarding the properties of the cable (such as temperature or voltage).
Increasing efficiency by decreasing the amount of time needed to determine whether a cable is safe to handle by providing easily identifiable labels that indicate whether or not the cable is safe to handle.

Various aspects of the present disclosure are described by narrative text, flowcharts, and line drawings of cables. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. A cable comprising:
a conductor;
a jacket surrounding the conductor; and
a chromogenic polymer coating applied to a surface of the jacket, wherein the chromogenic polymer coating is configured to change color based on a temperature of the chromogenic polymer coating exceeding a temperature threshold.

2. The cable of claim 1, wherein the temperature threshold is based on a predetermined unsafe-handling temperature.

3. The cable of claim 1, wherein the chromogenic polymer coating is applied to the surface of the jacket as a label, wherein the label indicates a temperature of the cable.

4. The cable of claim 3, wherein the label is visible only when the temperature of the chromogenic polymer coating exceeds the temperature threshold.

5. The cable of claim 1, wherein the chromogenic polymer coating is applied to a surface of a cable connector.

6. The cable of claim 1, wherein the chromogenic polymer coating is thermally coupled to the jacket.

7. The cable of claim 1, wherein the chromogenic polymer coating is configured to change to a color different from a color of the jacket.

8. The cable of claim 1, further comprising applying a second chromogenic polymer coating to the surface of the jacket, wherein the second chromogenic polymer coating is configured to change color based on a temperature of the second chromogenic polymer coating exceeding a second temperature threshold.

9. The cable of claim 8, wherein the second temperature threshold is different from the temperature threshold.

10. An apparatus comprising:
a first component;
a second component; and
a cable configured to connect the first component to the second component, wherein the cable includes:
a conductor;
a jacket surrounding the conductor; and
a chromogenic polymer coating applied to a surface of the jacket, wherein the chromogenic polymer coating is configured to change color based on a temperature of the chromogenic polymer coating exceeding a temperature threshold.

11. The apparatus of claim 10, wherein the temperature threshold is based on a predetermined unsafe-handling temperature.

12. The apparatus of claim 10, wherein the chromogenic polymer coating is applied to the surface of the jacket as a label, wherein the label indicates a temperature of the cable.

13. The apparatus of claim 12, wherein the label is visible only when the temperature of the chromogenic polymer coating exceeds the temperature threshold.

14. The apparatus of claim 10, wherein the chromogenic polymer coating is applied to a surface of a cable connector.

15. The apparatus of claim 10, further comprising a second chromogenic polymer coating applied to the surface of the jacket, wherein the second chromogenic polymer coating is configured to change color based on a temperature of the second chromogenic polymer coating exceeding a second temperature threshold.

16. The apparatus of claim 15, wherein the second temperature threshold is different from the temperature threshold.

17. The apparatus of claim 16, wherein the second chromogenic polymer coating is applied to the surface of the jacket as a second label.

18. The apparatus of claim 17, wherein the second label is visible only when the temperature of the chromogenic polymer coating exceeds the second temperature threshold.

19. The apparatus of claim 10, wherein the chromogenic polymer coating is thermally coupled to the jacket.

20. The apparatus of claim 10, wherein the chromogenic polymer coating is configured to change to a color different from a color of the jacket.
